(19) United States
(12) Patent Application Publication
(10) Pub. No.: US 2018/0212989 A1
(43) Pub. Date: Jul. 26, 2018

(54) SYSTEM AND METHOD FOR MONITORING, CAPTURING AND REPORTING NETWORK ACTIVITY

(71) Applicant: 1088211 B.C. Ltd., West Vancouver (CA)

(72) Inventor: Riaz Mavani, West Vancouver (CA)

(21) Appl. No.: 15/875,997

(22) Filed: Jan. 19, 2018

Related U.S. Application Data
(60) Provisional application No. 62/448,888, filed on Jan. 20, 2017.

(51) Int. Cl. H04L 29/06; H04L 12/26

(52) U.S. Cl. CPC H04L 63/1425; H04L 63/1416; H04L 43/028; H04L 43/04; H04L 43/026

(57) ABSTRACT

Methods and apparatus for monitoring and capturing network activities and producing network activity reports at predetermined, regular intervals are provided. Embodiments comprise capturing data passing through a network, organizing the data into flows between pairs of unique IP addresses, analyzing the data for pertinent information based on system and user-specified parameters, collecting and storing the information, and detecting potential security threats by identifying suspicious internet traffic. The information is collated and processed to identify an activity for each flow and produce an aggregate report at a user-specified cycle. The aggregate report is then sent to a user without user intervention. The activity for each flow may be identified through a packet data translation engine, based on keyword dictionaries and/or predictive logic.

### CROSS-REFERENCE TO RELATED APPLICATIONS

This application claims the benefit under 35 U.S.C. § 119 of U.S. application No. 62/448,888 filed 20 Jan. 2017 and entitled SYSTEM AND METHOD FOR MONITORING, CAPTURING AND REPORTING NETWORK ACTIVITY which is hereby incorporated herein by reference for all purposes.

### FIELD

The present disclosure relates to a system and method for monitoring, capturing and reporting network activity.

### BACKGROUND

United States Patent Application Publication No. 2004/0260801, which was published on Dec. 23, 2004 in the name of Li, discloses an apparatus and methods for monitoring and controlling network activity of network appliances. The network activity is transmitted to at least one controlling mobile communications device such as a cellular telephone or wireless telephone-enabled personal digital assistant. Internet access filtering technology is provided wherein Internet access of a monitoring network appliance may be selectively blocked based upon predefined rules. Information regarding Internet access activities, whether blocked or not, may be redirected to multiple controlling mobile communications devices for review based on other predefined rules. The predefined rules may be modified dynamically by sending a command from the controlling mobile communications device to the monitoring network appliance.

United States Patent Application Publication No. 2004/0158630, which was published on Aug. 12, 2004 in the name of Chang et al., discloses a method for monitoring and controlling network activity of one or more network appliances in real-time. The network activity of a network appliance may be monitored by the network appliance itself or, if the network appliance is in a LAN, by a network gateway in the LAN. The network activity is transmitted to one or more controlling network appliances based on which type of IP address is assigned to the monitoring network appliances and the controlling network appliances. The controlling network appliances control the network activity of the monitored network appliances by sending a command to the monitored network appliances with or without user intervention. The monitored network appliances execute the command to control their network activity in real-time.

There is a desire and need to provide improved systems and methods for monitoring, capturing and reporting network activity, in a manner accessible to a non-technical person and through a simple plug-and-play method.

### SUMMARY

One aspect of the technology described herein provides a network monitoring and reporting system for monitoring and capturing network activity, and producing network activity reports at predetermined, regular intervals. In addition to producing regularly scheduled activity reports via email, the system may provide on-demand network usage information on a mobile and web-accessible user interface.

There is also provided a method of monitoring and capturing network activity and producing network activity reports at predetermined, regular intervals. The method comprises 1) redirecting network traffic to the device and system, 2) copying and storing pertinent network packet header and data payload information, 3) combining the hitherto fragmented packet information into continuous ‘conversations’ between a host device and a destination device, called ‘flows’, 4) analyzing, translating, and compiling the data using activity identifiers and custom reporting logic to summarize device activities into aggregate reports. These reports may be presented as, but not limited to, emails, mobile or web reports. The reporting logic described in item (4) is comprised of a combination of encoded system parameters as well as user-specified parameters. The aggregate report may be sent automatically at a user-specified cycle. It is sent without user intervention, with additional options to manually generate and send reports on-demand. Real-time warnings may be generated based on user-specified parameters. A push notification to a web or mobile interface may be sent to a user device to alert the user of the real-time warning.

One aspect of the technology described herein provides a method of monitoring network activity, comprising monitoring incoming and outgoing packets communicated on a network to capture packet data, assembling the packet data into one or more flows, storing the one or more flows in a database, and processing the one or more flows to identify an activity for each one of the one or more flows. The information generated by processing the one or more flows may be provided in a report for communication to a user. Activity identification supported by the methods and systems described herein may include identifying a flow's activity type as one of: video streaming, audio streaming, social media, gaming, messaging, video calling, email, and/or web or other applications, and the like. Particular embodiments provide for activity identification based on the attributes defined for each flow.

In particular embodiments, the packet data is organized into flows of data exchanged between unique pairs of IP addresses on the network. From the packet data, attributes may be defined for each flow. Such attributes may comprise: source IP address; destination IP address; Domain Name System (DNS) request or query; DNS response IP address and name; Uniform Resource Locator (URL); sent packets; sent bytes; received packets; received bytes; ports accessed; start time; end time; and OSI Model Application Layer 7 deep packet inspection-derived (DPI) protocol fields.

Processing the flows may comprise using at least one of the following to identify the activity: Packet Translation Logic; DNS and DPI keyword dictionaries; port number tables; bandwidth thresholds; application layer protocols; Internet Protocol (IP) tables and Predictive Logic. Processing the flows may determine activity information, comprising one or more of: a start time and an end time for the activity; a duration of the activity; and a number of times that the activity was performed or accessed in a reporting period.

Conversations (packet transmissions between a pair of destination and source IP addresses) having the same activity type and accessing network device may be grouped together as one flow. Packet transmissions between a group of related destination IP addresses, for example a number of related servers providing coordinated content to a source IP address/device, are also considered a unique conversation. Successive conversations within the group, including those separated by pauses, are identified as comprising a continuous flow until a maximum pause duration between conversations is reached. Any conversation starting after the maximum pause duration has lapsed is detected as a separate and new flow from the previous flow.

In one embodiment of the technology described herein, a method of monitoring network activity comprises monitoring incoming and outgoing packets communicated on a network to capture packet data; assembling the packet data into one or more flows between unique pairs of IP addresses on the network; and for each one of the one or more flows: determining a first set of attributes based on the packet data in the flow, and processing the flow to determine an activity. Processing the flow may comprise determining a second set of attributes by using one or more attributes of the first set of attributes to derive the second set of attributes from a repository, and applying the second set of attributes to identify a first activity type. The repository may comprise a keyword dictionary which relates additional attributes to certain keywords parsed from the packet data.

The first set of attributes comprises one or more of: source IP address; destination IP address; Domain Name System (DNS) request or query; DNS response IP address and name; Uniform Resource Locator (URL); sent packets; sent bytes; received packets; received bytes; ports accessed; start time; end time; and one or more deep packet inspection-derived (DPI) protocol fields. The second set of attributes comprises one or more of: a category, a service, and a subcategory.

In some embodiments, processing the flow comprises applying predictive logic to one or more of the first set of attributes and the second set of attributes to identify a second activity type. Applying predictive logic may comprise identifying patterns in one or more of: upload and/or download speed (e.g. as compared with a baseline speed), bandwidth density, rate of transmission, duration of continued transmission, and number of requests sent by the requesting device.

A first weight may be assigned to the first activity type and a second weight assigned to the second activity type. The weight may be assigned based on a calculation of confidence levels in each activity type determination. The activity type with the greatest weight may be selected as the activity for the flow.

In particular embodiments, the activity information is reported electronically to a user on a user-specified schedule. The report may be transmitted to the user through one or more of: email communication, a mobile application, SMS messaging and a web interface. A real-time warning regarding the activity may be generated if the activity information satisfies certain predefined criteria (e.g. time of access, keyword filters, and certain web applications or usage). For example, certain websites or types of websites accessed by a device on the network may be flagged as a risk and may be monitored and/or trigger the generation of a warning.

Further aspects and example embodiments are illustrated in the accompanying drawings and/or described in the following description.

### BRIEF DESCRIPTION OF THE DRAWINGS

The accompanying drawings illustrate non-limiting example embodiments of the technology described herein.

FIG. 1 is a schematic diagram of an exemplary network environment in which a networking monitoring device operates;

FIG. 2 is a perspective view of the networking monitoring device;

FIG. 3A is a schematic diagram of the network monitoring device;

FIG. 3B is another schematic diagram of the network monitoring device;

FIG. 4 is a flowchart showing the logic of installing the network monitoring device and configuring network monitoring software stored on the network monitoring device; and

FIG. 5 is a schematic diagram of the exemplary network environment showing the data collection and reporting process.

FIG. 6 is a flowchart of a method for determining an activity of a flow according to one embodiment.

FIG. 7 is a flowchart showing the steps to be applied in respect of a network monitoring device for determining and reporting on user device activities according to one embodiment.

FIG. 8 is a schematic diagram of a flow between a source IP and destination IP(s).

FIG. 9 illustrates the types of activities that may be identified and reported on by a network monitoring device in accordance with one embodiment.

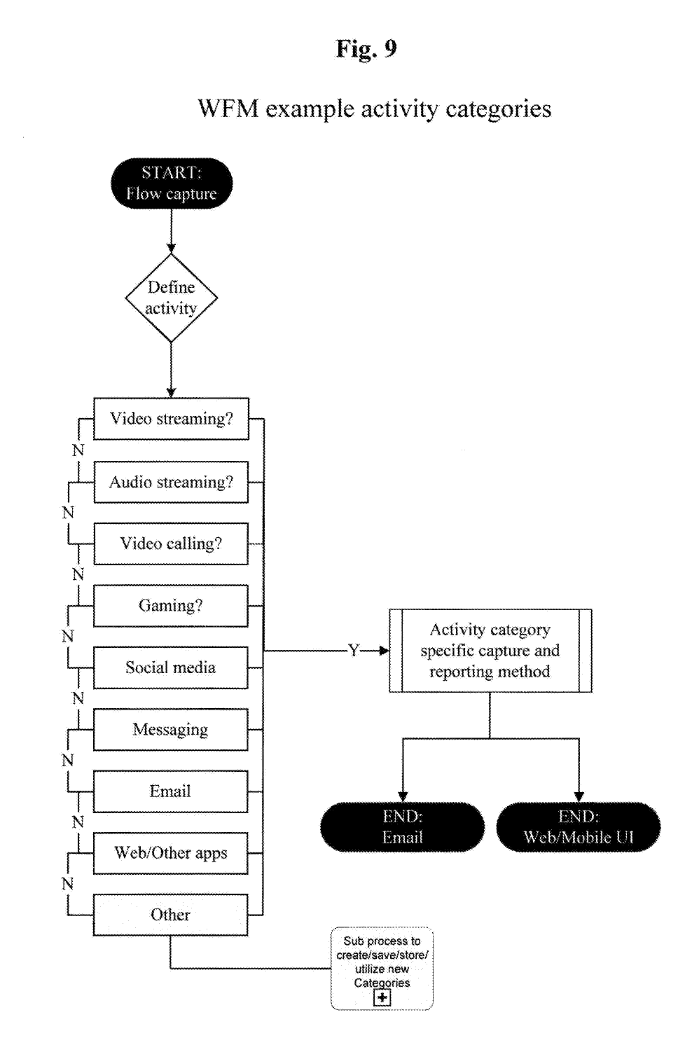

FIG. 10 illustrates overlapping video streaming activities accessed by the same device.

FIG. 11 illustrates the process of grouping activities within one example category, video streaming.

### DETAILED DESCRIPTION

Throughout the following description, specific details are set forth in order to provide a more thorough understanding of the invention. However, the invention may be practiced without these particulars. In other instances, well known elements have not been shown or described in detail to avoid unnecessarily obscuring the invention. Accordingly, the specification and drawings are to be regarded in an illustrative, rather than a restrictive sense.

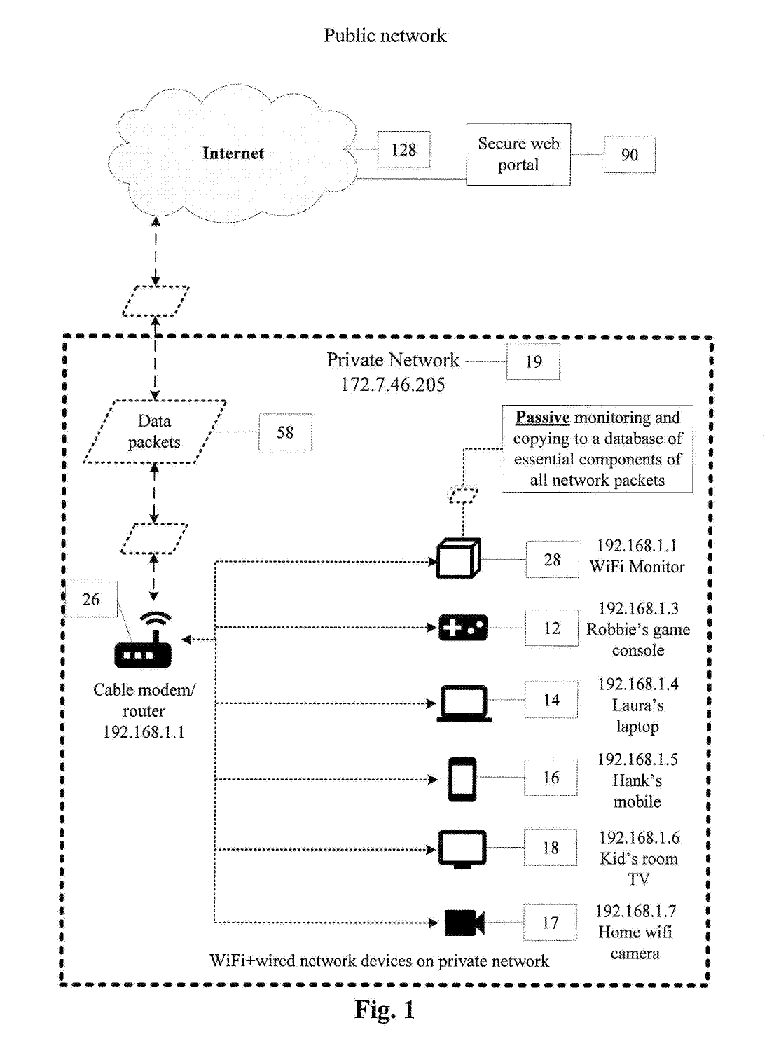

Referring to the drawings, FIG. 1 illustrates an exemplary network environment in which monitoring and reporting user activity on a network may be implemented. In this example, the network environment is a private network 19 which includes a plurality of network devices, for example, game console 12, laptop 14, mobile phone 16, television 18 and home camera 17. It will be understood by a person skilled in the art that the private network 19 may further comprise additional network devices that have not been shown (such as, for example, desktop computers, tablets, media players, media consoles, smart consumer electronics, and/or other network-enabled devices). The network devices are connected to a public network which, in this example, is the Internet 128. The network devices are connected to the Internet 128 by a network gateway device which, in this example, is a wireless combined modem/router 26. The private network 19 also includes a network monitoring device 28 connected to the modem/router 26 which monitors, redirects, captures, and analyzes data packets 58 transmitted between devices on the private network 19 and the Internet 128, for reporting purposes.

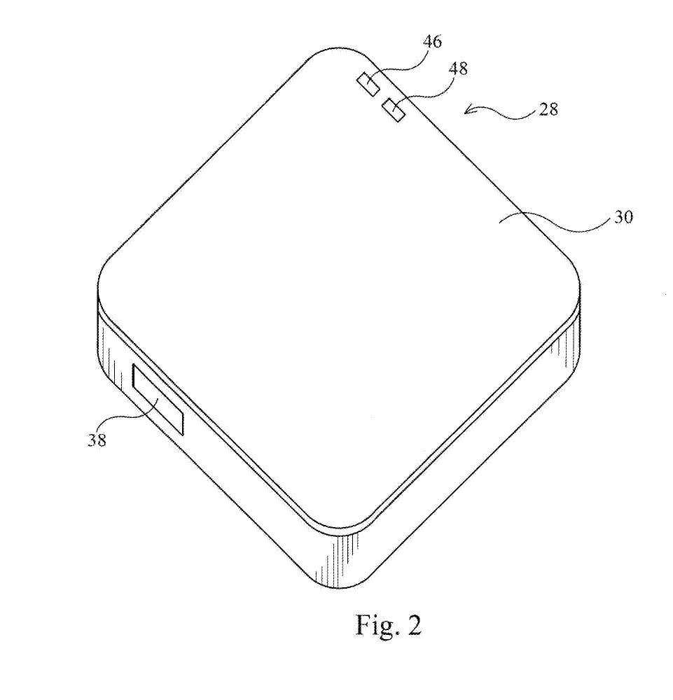

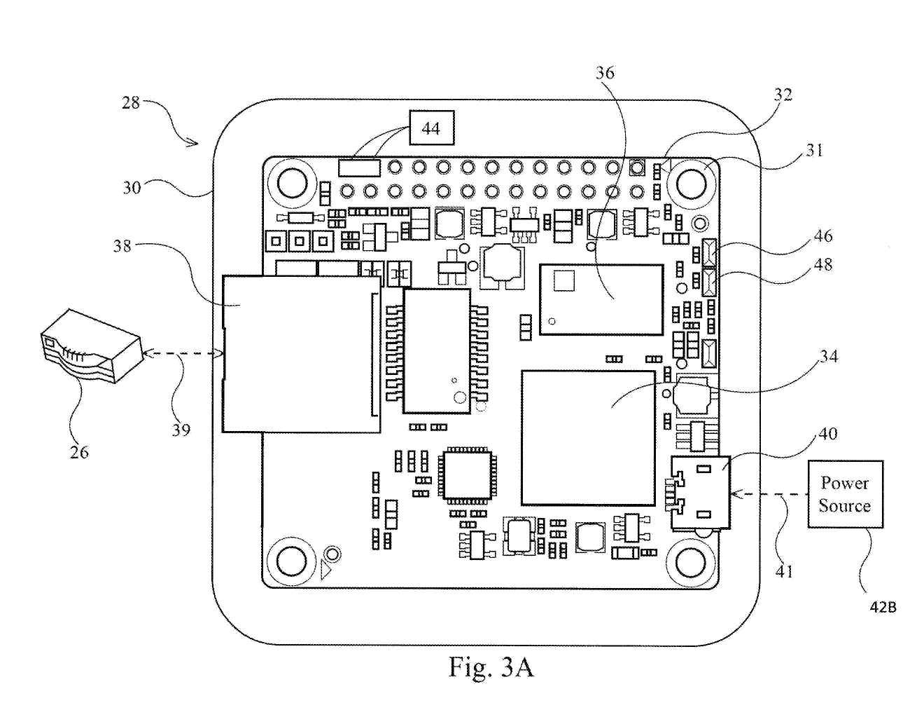

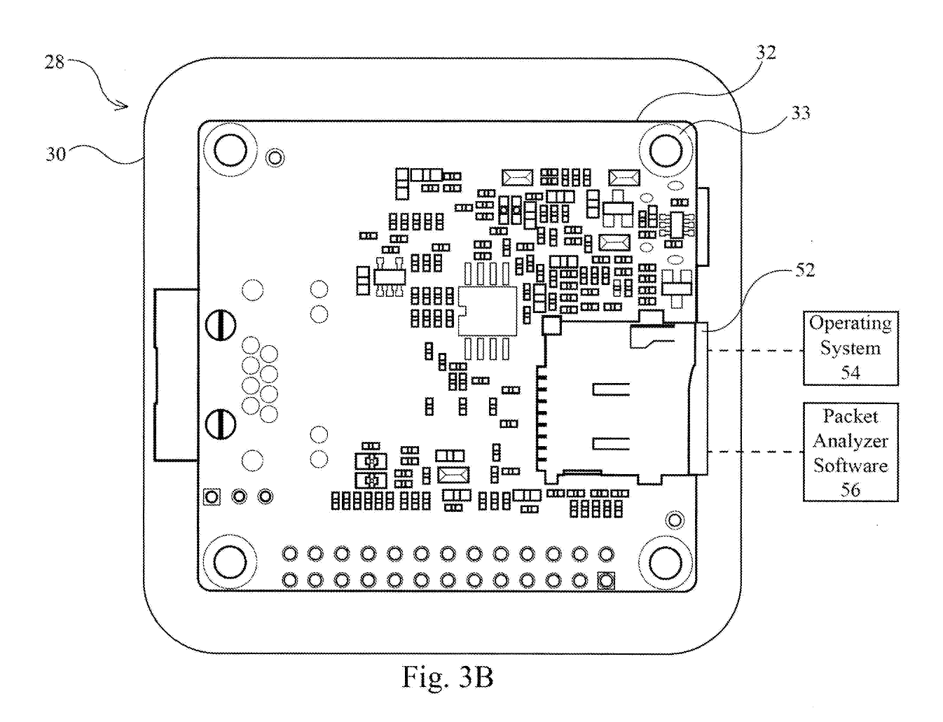

An example network monitoring device 28 is shown in greater detail in FIG. 2 and includes a housing 30 which is substantially rectangular in shape in this example. However, the housing 30 may be other shapes in other examples. The network monitoring device 28 further includes a circuit board 32 disposed within the housing 30 as best shown in FIG. 3A. Mounted on a first side 31 of the circuit board 32 is a processor 34, a random-access memory 36, an Ethernet port 38 and a micro-USB port 40. The Ethernet port 38 allows the network monitoring device 28 to be connected to the modem/router 26, for example, via an Ethernet cable 39. Another embodiment of the device may be designed with two Ethernet ports, allowing the device to be connected to the modem/router via two ports. Another embodiment of the device may feature wireless connectivity to the modem/router, eschewing the need for a wired Ethernet connection. The micro-USB port 40 allows the network monitoring device 28 to be connected to an external power source 42B, for example, via an USB cable 41. The device may also be powered via an AC to DC power transformer (for example, a 5V/2A power supply). The network monitoring device 28 may also be provided with a backup power source in the form of a battery 44. The circuit board 32 may further include status indicators, which in this example are visual indicators in the form of light-emitting diodes 46 and 48. The light-emitting diode 46 may indicate whether the network monitoring device 28 is powered on, and the light-emitting diode 48 may indicate the status of the network.

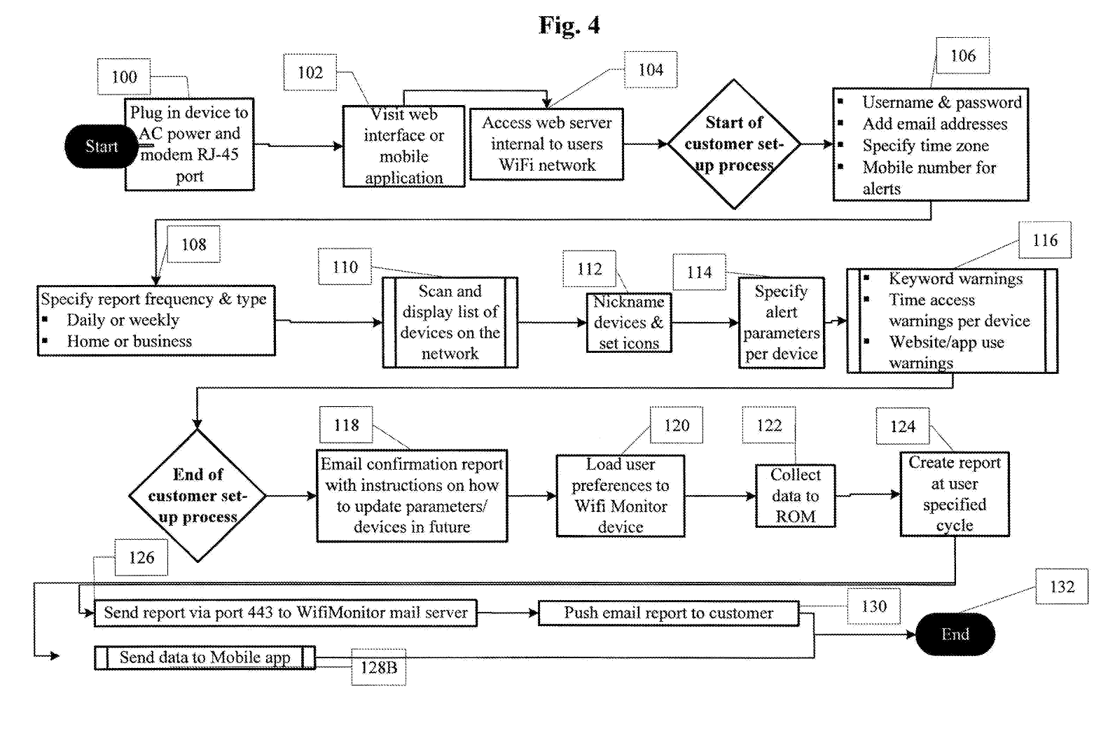

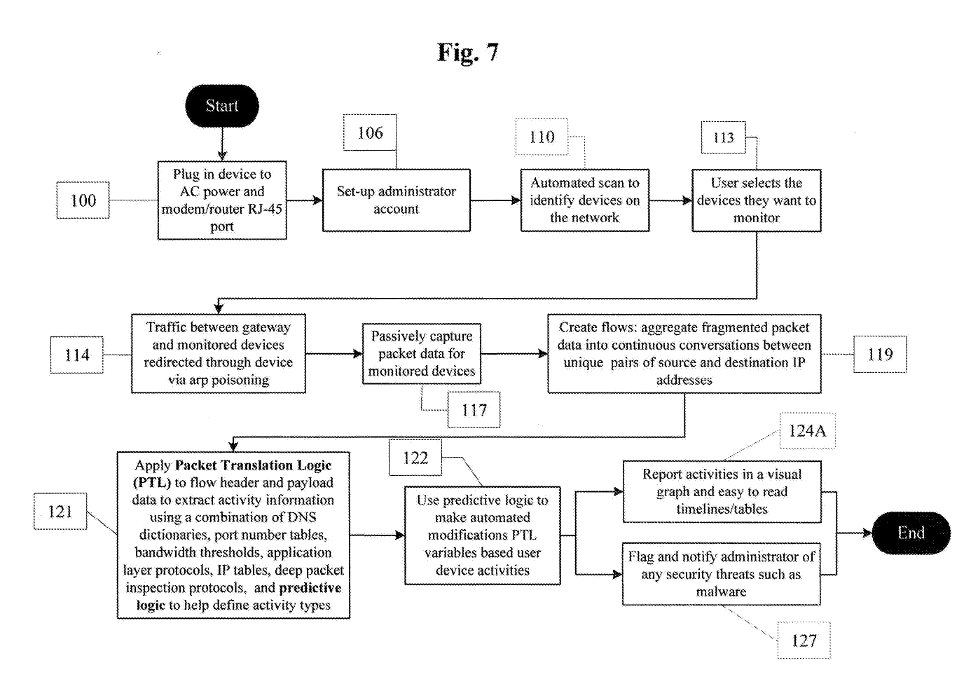

Referring now to FIG. 3B, the circuit board 32 has a second side 33 which is provided with a read-only memory 52. Preloaded in the read-only memory 52 is an operating system 54 which may be a Linux® operating system such as Ubuntu®. The read-only memory 52 is also preloaded with a custom developed packet analyzer software 56. When the network monitoring device 28 is plugged into the modem/router 26 and powered on (see also block 100 of FIG. 7), the operating system 54 will load and the light-emitting diode 46, shown in FIG. 3A, will turn on. Monitoring of all devices connected to the modem/router will be defaulted to ON and the packet analyzer software immediately initiated. Referring to FIG. 4, the user is instructed to log onto a web portal at block 102 via a predetermined URL (example my.wifimonitor.com), to establish a connection to the network monitoring device 28 and the private network 19. The user is then directed to set up an administrator profile and reporting parameters (see also block 106 of FIG. 7).

FIG. 4 is a flow chart showing the logic of installing the network monitoring device 28 and configuring the packet analyzer software 56. The network monitoring device 28 is first connected to the power source 42B and to the modem/router 26 at step 100. Connecting the monitoring device 28 to the router/modem automatically results in the device scanning and detecting all connected clients to the modem/router (see also block 110 of FIG. 7). The default monitoring status for devices on the network is set to OFF. A user then logs onto the web portal or mobile application 90 at step 102 of FIG. 4, for example, by using one of the network devices such as the laptop 14. Selecting the web portal or mobile application will direct the user to a login screen on the user's private network 19 at step 104. The user is then prompted to create a secure user account by providing details such as a username, password, one or more email addresses, and a mobile phone number at step 106. The network monitoring device 28 comprises a web server which provides the web portal functionality and enables the user to login to the web portal within the private network 19.

By scanning network 19 for clients connected to the gateway when the monitoring device was initially plugged in, the monitoring device 28 is able to recognize all network devices which have been assigned an Internet Protocol address (IP address) within private network 19. A list of the network devices and their respective names is displayed for the user on an interface at step 110, who is then given an option to rename or “nickname” the devices at step 112 for ease of reference, e.g. “Tom's phone”, including options to use system-assigned icons for each device or custom uploaded photos as device icons. Devices not on private network 19 at the time of setup can be added at a later time by visiting the web portal or mobile application 90 and selecting an icon to refresh the device list by scanning the network again. The user may select the network devices that they want to monitor (block 113 of FIG. 7).

The user next specifies their preferences for network activity reports. The appropriate time zone may be selected by the user at step 106 or may be automatically detected. The user provides one or more email addresses or a phone number to receive the network activity reports, specifies the frequency of reports (e.g. daily or weekly), and selects the appropriate type of report (e.g. for home or business) at step 106. The user may also specify alert parameters for each network device at step 116 based on, for example, keywords, time, or website or application usage. At the conclusion of the setup process at step 118, the user may receive an email confirmation that monitoring device 28 is fully set-up and functioning, as well as instructions on how to update preferences and devices in the future. The user's preferences are loaded onto network monitoring device 28 at step 120 to commence the data collection process.

Once monitoring device 28 is plugged in and activated, the network monitoring remains OFF until such a time that monitoring device 28 is configured to passively collect data on specific devices. Once devices are chosen to be monitored, network monitoring device 28 begins collecting and storing network packet data according to each active device in the private network 19, using key identifiers such as the device MAC address, which is permanent and static, and IP address (which is subject to change). This involves accessing two commonly used network protocols, namely, User Datagram Protocol (UDP) and Transmission Control Protocol/Internet Protocol (TCP/IP). Various steps and software utilities may be used to accomplish the purpose of the network monitoring device 28 as detailed below.

Step 1 comprises redirecting network traffic through monitoring device 28. This may be performed by one of several custom-created or open sourced utilities (for example Arpspoof, or Ettercap), as shown in FIG. 7, block 114. These custom-created or open sourced utilities are loaded on network monitoring device 28. They may operate to redirect traffic by spoofing the gateway (modem/router) by continuously sending false information to devices on either side. Redirecting traffic results in all data packets that under normal circumstances are transmitted through the gateway (modem/router) from an internal device in the network en route to an external server, instead first being sent to monitoring device 28, effectively placing monitoring device 28 as an intermediary for outgoing network traffic prior to passing through the gateway.

In a similar fashion, incoming traffic intended for a specific device in the network, first passes through the gateway and is redirected to monitoring device 28 prior to reaching the intended device in the network. Devices that are chosen by the user to be monitored and tracked (e.g. via a user interface ON/OFF toggle switch) would thus be ‘spoofed’ to allow their traffic data to be redirected to—and logged by—the network monitoring device 28. The technique of redirecting outgoing and incoming traffic through monitoring device 28 may be understood as a 2-way spoofing technique. Another embodiment of the device may use a one-way technique to capture only outgoing traffic.

In some embodiments, security features such as malware and SPAM detection may be provided by monitoring device 28. Malware or SPAM may be detected by identifying unusual outbound internet traffic from network devices. Uncharacteristic internet traffic is detectable as outbound internet traffic that might for example suggest that a device is sending emails or other data. Suspect servers can be identified using known spam servers, email servers, fraudulent websites or not normally used top level country domains. Risk factors such as server/domain names, the time of day, frequency of traffic as well as the amount of data can be used to ascertain if a device is possibly infected with malware. A weighted scoring system using risk factors may be implemented to help flag internet traffic that may be related to malware or SPAM. If traffic to or from a device is flagged as a potential security threat (an ‘event’) then the device is further monitored to determine if the event is frequent enough to suggest the traffic pattern may indeed be a security issue. For example, if a laptop on the network has several flagged flows over a 24-hour period then there is enough evidence to warrant notifying the admin of the possible threat.

Once a threat is identified, as shown in FIG. 7 at block 127, the network administrator of the device may be notified of the potential security threat, and given the ability to redirect the device's browser to a Security Warning page. This may be accomplished through the redirection of traffic from the suspect device to a locally hosted web server within monitoring device 28. This may be accomplished for example using readily available open source methods such as DNS spoofing. The Security Warning page may give the user access to an online malware/anti-virus scanning tool, which is used to verify and clean any potential threats.

In addition, the security feature may include setting access schedules for particular devices on the network. Such access schedules, for example, may permit certain network devices to access only certain sites, or only at certain times of the day, or prohibit the network devices from accessing certain sites, or at certain times of the day, and/or restrict the duration of a particular activity.

Step 2 comprises all redirected (monitored) traffic being saved by an open sourced packet capture software (also known as “packet sniffers”) which captures specific components of the network data packet header and payload body fields to a database (FIG. 7 at block 117). The captured packet data may be stored locally on a memory of monitoring device 28. Data collected from packets to and from each network device may include source IP address and name, destination IP address and name, data packet timestamp, DNS request, packet size (in bytes), protocol, and ports.

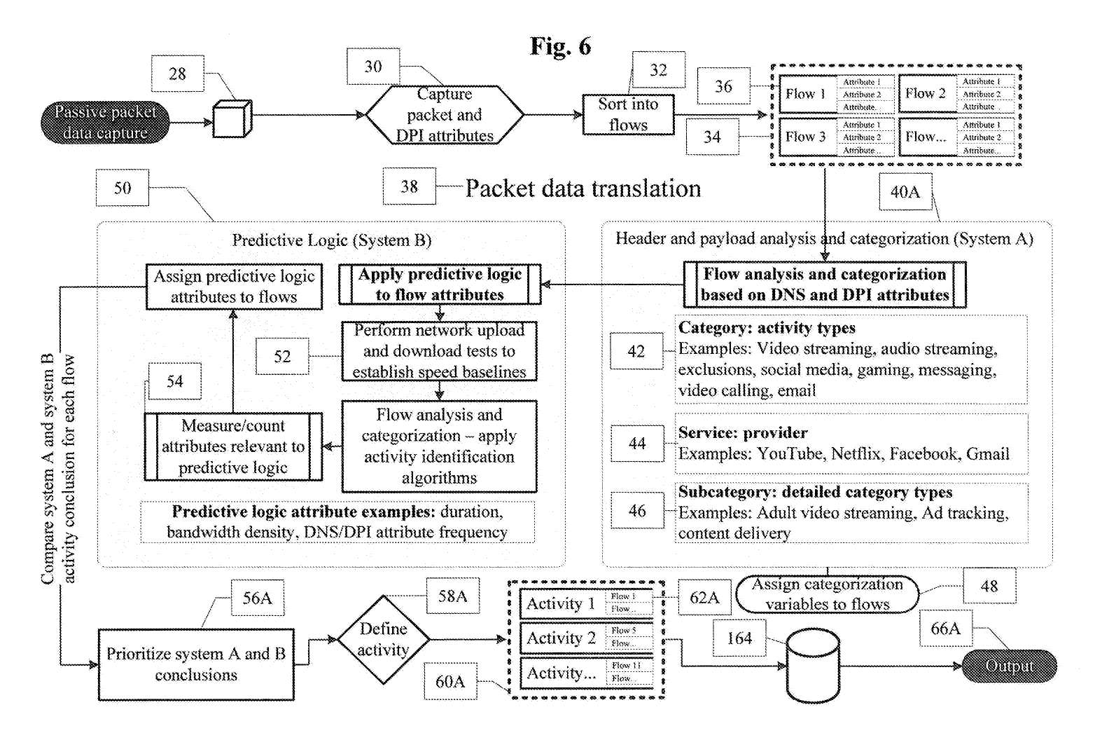

As illustrated in FIG. 6, Step 3 comprises the network monitoring device's 28 packet analyzer software combining the fragmented captured packet information 34 to create summarized conversations—called ‘flows’—(typically) between a local device on network 19 and a remote host. Processing fragmented captured packet information 34 to identify flows may be based on custom-created criteria in the software (see block 119 of FIG. 7). The criteria may comprise obtaining the source IP addresses and destination IP addresses of each packet, and identifying unique pairs of source IP addresses and destination IP addresses between the incoming and/or outgoing packets. Destination IP addresses may be grouped if related to the same activity or service (such as YouTube™ video streaming for example).

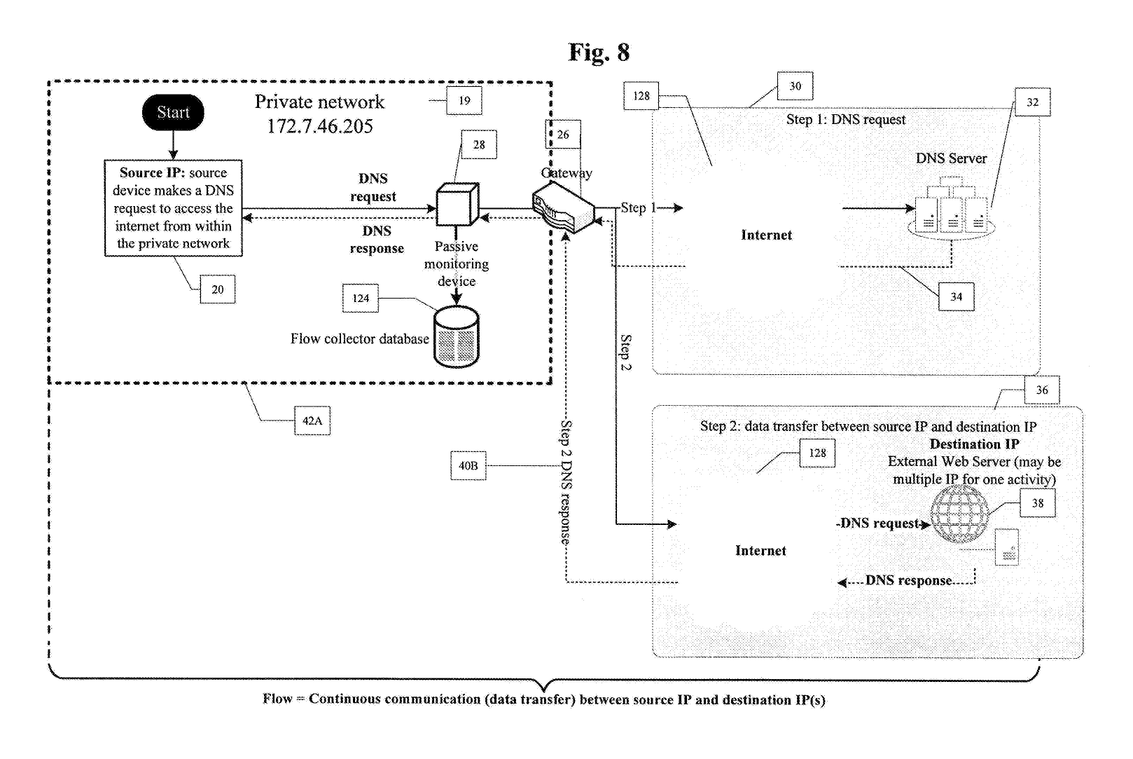

Thus, one method of creating flows is to organize the packets into conversations between unique sets of IP addresses. As illustrated in FIG. 8, suppose a captured packet incoming to a local network 42A comprising devices connected to a private WiFi network 42A has a source IP address 38 of 69.31.163.2 and a destination IP address 20 of 192.168.1.4 pointing to a device on a private WiFi network 42A (via the publicly available gateway IP address for the Wi-Fi network 42A), and a captured outgoing packet has a destination IP address 69.31.163.2 38 and a source IP address of 192.168.1.4 20 (via the publicly available gateway IP address for the Wi-Fi network 42A). Because the incoming packet's source IP matches the outgoing packet's destination IP, and the outgoing packet's source IP matches the incoming packet's destination IP, the incoming and outgoing packets will be recognized as being part of the same ‘flow’, or conversation.

In some cases, a flow may comprise captured incoming packets having the same pair of source IP and destination IP addresses (e.g. source IP of 192.168.1.4 and destination IP of 69.31.163.2). In many other cases, incoming packets may originate from a diverse number of IP addresses. In these cases, flows are constructed using other packet characteristics such as packet sequence numbers, or a DNS identification number that allows the grouping of multiple responding IP addresses into a single conversation, or flow. An activity may also comprise more than one flow. For example, where the activity is viewing a YouTube video stream, pauses in the transmission may result in multiple flows being created for the same activity session. Downstream reporting logic may then report these multiple flows or conversations as one “YouTube” viewing activity.

As shown in the embodiment of FIG. 8, two main steps may be performed to create a flow. The first step occurs when a device in the local network 42A makes a DNS request for a service on the internet at step 30. A service may be defined by the activity source. Examples of services include CNN™, YouTube™, Netflix™, and google.com. For example, take the case of an iPad™ device as the requesting device viewing a video at www.youtube.com. The request is sent out from the requesting device. The request is passively captured by network monitoring device 28 and stored in database 124 of monitoring device 28, and goes to the modem/router 26 where it is sent out to the internet 128 to a DNS server 32. The DNS server provides the correct IP address for www.youtube.com and sends it back via the same route to the requesting device (or source IP) at step 34. Once the correct destination IP is ascertained, the requesting device sends out a DNS request at step 36 and connects to the destination IP address 38, after which the actual data transmission occurs at step 40B (DNS response). The transmission may include website or application data or streaming video data for example. This constitutes the second step in the process.

A flow represents the continuous transmission of traffic or a continuous communication between a source IP and a single or multiple destination IPs representing a single service. Pauses of up to a certain duration may be allowed before breaking/ending the flow. If the transmission restarts after the pause, a new flow is created. Otherwise, if it restarts within the pause, the same flow is continued. In certain embodiments the maximum pause duration is 120 seconds, after which the transmission is no longer considered continuous and a new flow is started for any packets transmitted after the pause.

Data from flows may be stored on a database 124 contained within monitoring device 28. In one embodiment, each flow comprises one or more of the following attributes, which may be saved to a repository:
Source IP;
Destination IP;
DNS request/query;
DNS response IP and name;
URL;
Sent packets;
Sent bytes;
Received packets;
Received bytes;
Ports accessed;
Upload and download bandwidth;
Start time;
End time;
DNS identification number;
Packet sequence number;
Duration; and
Deep packet inspection-derived (DPI) fields.

FIG. 8 illustrates the flow between a source IP address of a device 28, located within the local network 42A, and a destination IP address of an external internet-connected web server 38. At the source IP, the source device makes a DNS request to access the internet from within the local network 42A. The DNS request is collected by the passive monitoring device 28 and stored in the flow collector database 124.

In step 4, and as illustrated in FIG. 6, custom-created logic 38 is applied to each flow 36 captured in the database for each monitored device on the private network. This logic applies rules and characteristics (utilizing varying combinations of components captured in the flow) to each flow and translates them into understandable and readable activities 52. In particular embodiments, packet translation logic (PTL) 38 may be applied to extract information using a combination of keyword dictionaries, port number tables, bandwidth densities and thresholds, application layer protocols, IP tables and/or predictive logic to define activity types (see blocks 121 and 122 of FIG. 7). Examples of the types of activities that may be determined by applying the reporting logic to flows include, but are not limited to:
Device A spent 1 hour streaming Video from an online video service provider between a start time A and stop time B;
Device B accessed a social media website 10 times at specified times in the reporting period; and
Device C spent 1 hour playing online games between start time A and stop time B.

Flows 62A may be processed through a packet data translation engine (PDTE) to determine the activity 38. In the process, the flows that do not relate to a defined activity may be excluded or filtered. The remaining flows are aggregated into activities 60A.

The packet data translation engine (PDTE) may be divided into two parts (Systems A and B in FIG. 6). In FIG. 6. System A and System B are illustrated as being implemented sequentially, although in practice they may be implemented simultaneously. System A at block 40A comprises considering packet attributes to make a first pass analysis to determine the activity. In doing so, it assigns additional attributes to flows by comparing data points within the flow against a database or repository. Such additional attributes may comprise attributes such as category 42, service 44, and subcategories 46. For example, if the flow contains a DNS request keyword such as ‘googlevideo’, this may match a record in the database with “YouTube” as the SERVICE, and “video streaming” as the CATEGORY.

If the video is from a website that is flagged by the system (e.g. for having potentially unsafe content or being a security risk), an additional subcategory 46 may be assigned. For example, if the video is from a known pornography website, the additional subcategory “Adult streaming video” may be assigned. This subcategory can then be used to highlight or flag the activity.

As a database is finite in nature, it may not encompass all types of sites or applications accessed by a network device. Thus, where a match cannot be located in the database, the activities may be self-identified through System B using predictive logic (smart rules) 50 to identify activities.

An initial step in identifying activities in System B entails establishing a baseline network speed 52 for the private network. Network speeds vary from private network to private network depending on a range of factors such as network equipment such as routers and modems, device limitations, and the Internet Service Provider's (ISP) allocated speed and capacity for example. Furthermore, these baseline speeds establish the denominator against which can be measured device upload/download speeds while engaged in various internet activities. The baseline speed establishes a reference point to which the upload/download speed of the activity can be normalized. For example, if the baseline speed of the private network is 150 MB/s, then video streaming activity occurring on that network may be identified as being in proportion to a baseline speed of 150 MB/s. Normalizing the upload/download speed for different activity types enables the identification of activities on different private networks having different baseline speeds, since the upload/download speed of each activity type may vary in proportion to the baseline network speed.

The second step is to apply algorithms to the flows based on established patterns for differing types of activities at block 58A. For example, a method for identifying video streaming may comprise detecting whether there is a certain rate of transmission (in average megabytes per second) for more than a certain amount of time (e.g. 2 minutes). Another example: a method for identifying whether a device is sending out SPAM may comprise detecting repetitive SMTP requests. The method may comprise flagging the SMTP requests where a certain pattern of SMTP requests is detected (using specific port numbers such as 25, 465, and 587 for example). Conclusions drawn from these algorithms may result in additional attributes being applied to each flow.

Systems A and B may be mutually reinforcing, but it may happen that both result in differing interpretations of the activity (e.g. System A may identify the flow as YouTube video streaming, but System B may identify it as browsing the YouTube app or website, and not actually playing video). In this case the system may prioritize each conclusion at block 56A by defining the activity using System A where one exists, instead of System B. System A refers to definitive criteria to identify specific activities. Where no System A conclusion is available, a System B activity conclusion and definition is applied. System B is interpretive based on data analysis of criteria such as bandwidth density and duration. System A is prioritized over System B due to the definitive nature of the captured packet data within this system, in that the combination of data points within the system assigns an extremely high probability of accurate assignment of the activity.

The activity information 60A may be saved to a database 164 in the device for eventual output 66A. The reporting of the activities may be delivered electronically in one of several ways, such as via email, mobile application, a web interface, and the like.

At the reporting cycle specified by the user during the setup process—for example, daily or weekly—the packet analyzer software 56 will collate the data of each active network device and produce an aggregate report at step 126 shown in FIG. 4. The report may be in the form of a Unicode, HTML, or plain-text email. The report data is sent through a mail server at step 128B. Finally, the report data is transmitted to the one or more email addresses provided during the setup process at step 130. Alternatively, or additionally, the report data may be sent to a mobile application or smartphone application (e.g. such as via a push notification at step 132). In other embodiments, the report data is provided in other formats or in other ways such as through a web interface.

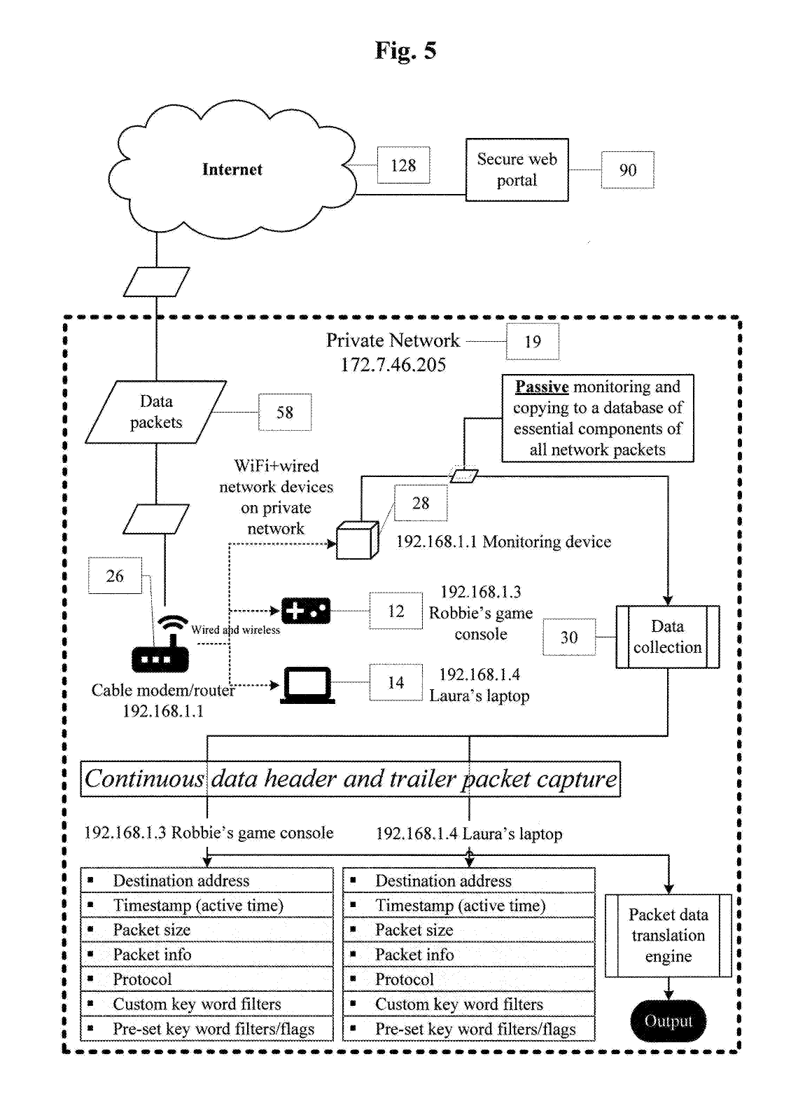

FIG. 5 is a schematic diagram showing the data collection and reporting process. Data packets 58 are transmitted between the private network 19 and the Internet 128. The necessary data for reporting purposes are collected from data packets 58 on a per device basis at data collection step 30. In this example, data is collected for the game console 12, laptop 14, respectively. The data is inspected and cross-referenced to other data to create relevant reports. The packet analyzer software 56 collates the data 2. An aggregate report is then produced and sent to the user.

The user can set up rules 116 on the web or mobile portal 90 specifying parameters which generate real-time warnings. For example, if a network device accesses a certain website during a certain period of the day, then a notification may be sent to the user's device via email, text message or a push notification. The user may also utilize keyword filters to generate an instant notification or a flag in the report. The keywords can be user-specified or based on pre-set keyword tables available on the web portal 90. Data collected by the packet analyzer software may be stored on cloud infrastructure to allow users to perform time-based analysis through a smartphone application. If the network monitoring device 28 is unplugged for a period of time, a notification may be sent to notify the user immediately. This may be implemented by having the network monitoring device 28 continually ping the gateway (modem/router). The pinging does not require Internet connectivity. If the pinging is discontinued, then this is an indication that the network monitoring device 28 may have been unplugged from the network, and/or disconnected from a power source. When pinging resumes (i.e. the network monitoring device 28 is plugged in again), the network monitoring device 28 calculates the duration of the outage and sends an email alert. A third party email server may be used to initiate the process of sending the alert. In some embodiments, a backup battery 44 on network monitoring device 28 enables the network monitoring device 28 to send an alert even while it is unplugged from a power source, provided that the network monitoring device 28 is still connected to the Internet, via, for example, an Ethernet connection. Alternatively, or additionally, the event can be included in the activity report (see also block 124A of FIG. 7).

Providing a separate and secure maintenance web portal 90 advantageously allows for technical troubleshooting and updating of the device software bundle by allowing the provider of the network monitoring device to access the network monitoring device directly remotely via a pre-installed two-way communications Secure Shell (SSH) tunnel.

Unlike conventional systems and apparatuses for controlling network activity, certain embodiments of the network monitoring device 28 do not actively filter data transmitted through the private network 19. In other words, the network monitoring device 28 does not block specified data packets and therefore access to specific websites. Rather, network monitoring device 28 monitors and copies and stores to the device memory the necessary components from each transmitted data packet flowing through the private network 19 to produce its network activity reports. Since network monitoring device 28 is not actively filtering payload data transmitted through the private network 19, there is minimal impact on network speed. In addition, unlike conventional systems for controlling network activity, network monitoring device 28 utilizes a “push” system of reporting, as opposed to a “pull” system. In other words, network monitoring device 28 sends out reports (e.g. at a regular interval) rather than depending on the user to “pull”, or seek, a report. The interval may be predetermined based on user preferences. However, in some embodiments, a security feature (as described elsewhere herein) may be provided to block traffic from certain websites from being transmitted to devices on the private network. The security feature works alongside network monitoring device 28 to protect devices in the network from sites which have unsafe content or pose a security risk.

In particular embodiments, information captured in the flows include deep packet inspection-derived protocol (DPI) fields, extracted from the OSI Model Layer 7 (Application layer). DPI may be included in System A, for example. DPI fields may comprise those supported by the nDPI open-source GPL library, for example. These fields are parsed, and a search is performed to locate a corresponding record in a keyword dictionary containing a match to the parsed DPI field. In one embodiment, a daily report table of the flows is generated, and the DPI protocol fields in the daily report table are parsed to extract the relevant protocol. As an example, the DPI_protocol “QUIC.YouTube” may be parsed to remove all text before and including the period symbol, so that the parsed field is “YouTube”. Where the parsed DPI protocol is blank or is unknown (i.e. it does not match an entry in the keyword dictionary), and the predictive logic process yields no further information, “OTHER” is assigned to DPI category for the flow. However, if the DPI protocol is assigned (i.e. there is a matching entry in the keyword dictionary), then the corresponding DPI category is assigned to the flow. For example, in the scenario provided above, there may be a DPI category entry of “Video streaming” in the keyword dictionary corresponding to DPI protocol “YouTube”.

The next step is to attribute keyword-based and port-based categories and sub-categories to all flows in the daily report table. For each flow, the DNS request text string is checked for keyword matches in a reporting database repository. If a match is found, then a keyword category, a keyword service and a keyword subcategory are assigned to each flow based on the keyword match. If there is no match, then additional criteria from the captured flow are analyzed by the PDTE. For example, certain TCP and UDP port numbers are specifically reserved and assigned for particular services by the Internet Assigned Numbers Authority (IANA). Thus, when a keyword-based match fails, the flow's port number(s) may be checked against the PDTE's reporting database repository of port numbers. If a port match is found, then a keyword category, keyword service and keyword subcategory are assigned to each flow based on the port number match. If there are no keyword or port number matches, and the predictive logic process yields no further activity identification, then “OTHER” is assigned to each of the keyword category, keyword service and keyword subcategory.

To clean up the daily report, flows which are irrelevant or insignificant to the user may be removed or deleted. This may comprise, for example, deleting flows with the keyword category “Exclusions” from the daily report table, deleting any flows with less than 1 second duration from the daily report table, and/or for certain types of activities, deleting any flows having total upload/download bytes outside defined thresholds (e.g. the threshold may be in the range of 25 kB to 1 MB, depending on the type of activity). Examples of excluded flows include advertising trackers which are passively installed on browsers to detect user browsing behaviors for targeted advertisements.

Methods for identifying activity types of flows and information associated with the activity of each flow are described below with reference to examples. In the case of video streaming activities, the method may comprise initially attempting to define the video streaming activity based on certain fields. For example, if a flow's keyword category=“Video streaming”, or the DPI category=“Video streaming”, then the flow is identified by its “keyword service”, “DPI service”, and/or “DPI protocol”. However, if the flow cannot be identified by these fields, then the video streaming activity may be defined or summarized using the predictive logic process referred earlier.

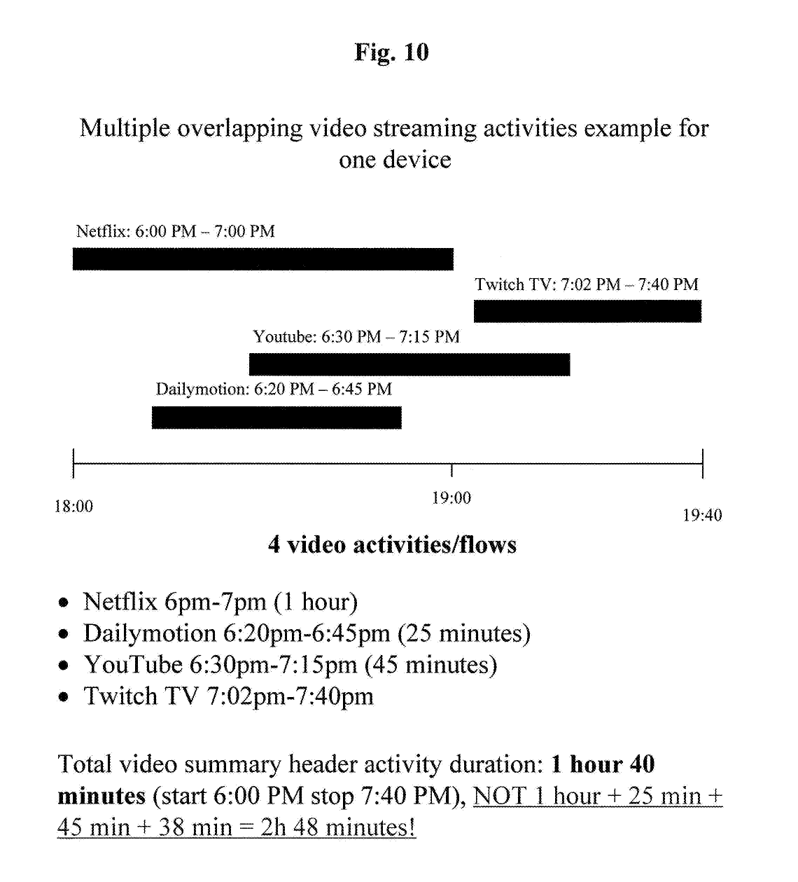

Statistics for different categories of use are calculated to most accurately reflect active (versus passive) use by the user of that category of use. For example, if there are overlapping video activities within a reporting period for a single device, but using different services, such as Netflix and YouTube, the activities may be calculated as a single video duration in determining the reporting statistic (see FIG. 10).

In the device detail section of the user report, the video streaming activity is inserted into time table format based on start time. The video streaming activity in the report is identified by keyword service or by a DPI protocol, or a combination of both. An example activity time table is shown below wherein the activities are shown sorted by chronological order based on their start time.

| Start | End | Activity | | Duration |
|---|---|---|---|---|
| 11:45 PM | 12:06 AM | YouTube | ▾ | 21 m |
| 12:00 AM | 12:23 AM | Instagram | ▾ | 23 m |
| 12:06 AM | 12:06 AM | Google.com | ▾ | |
| 12:09 AM | 12:18 AM | YouTube | ▾ | 9 m |
| 1:01 AM | 1:02 AM | Streaming content delivery | ▾ | 1 m |
| | | (Apple device) | | |
| 2:51 AM | 2:51 AM | Gmail (may be automated) | ▾ | |

Activities may be presented in a way to better differentiate important or active activities and non-important or passive activities. This may be accomplished, for example, by formatting fonts into three categories: grey, normal, and bold fonts. In addition, up and down arrows may be used to indicate if the majority of captured data is downloaded or received bytes (down arrow), or uploaded or sent bytes (up arrow). In particular embodiments, the threshold for the arrows is 50% of the overall bandwidth of the flow. Thus, if received bytes is equal to 50% or more of the flow, then the report displays a down arrow; otherwise, it displays an up arrow.

Report text may be further modulated and adjusted by upload and download flows, as well as by Keyword Categories, such as Video streaming and Social Media. An example matrix controlling font formats is show below:

| | Enter threshold bytes | | | | | |
|---|---|---|---|---|---|---|
| | Upload (sent bytes) | | | Download (received bytes) | | |
| Activity type | Light | Normal | Bold | Light | Normal | Bold |
| Video streaming | 100,000 | 100,001-999,999 | 1,000,000 | 1,000,000 | 1,000,001-9,999,999 | 10,000,000 |
| Audio streaming | 100,000 | 100,001-999,999 | 1,000,000 | 1,000,000 | 1,000,001-9,999,999 | 10,000,000 |
| Social media | 100,000 | 100,001-999,999 | 1,000,000 | 500,000 | 500,001-4,999,999 | 5,000,000 |
| Web & other apps | 100,000 | 100,001-999,999 | 1,000,000 | 1,000,000 | 1,000,001-9,999,999 | 10,000,000 |
| Email | 100,000 | 100,001-999,999 | 1,000,000 | 1,000,000 | 1,000,001-9,999,999 | 10,000,000 |
| Messaging | 10,000 | 10,001-99,999 | 100,000 | 10,000 | 10,001-99,999 | 100,000 |
| Gaming | 100,000 | 100,001-999,999 | 1,000,000 | 1,000,000 | 1,000,001-9,999,999 | 10,000,000 |

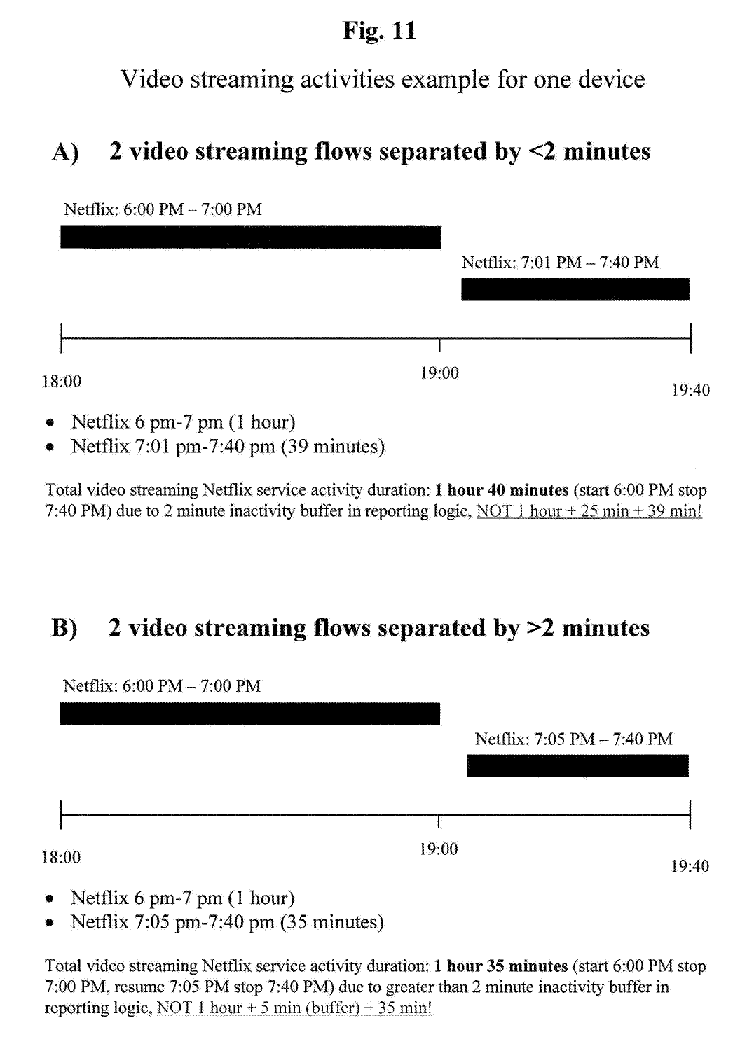

The presentation of daily captured and interpreted data may vary according to the needs of the user. In certain embodiments, all activities may be grouped firstly by device, with activities arranged chronologically by start and end times. In other embodiments, activity data may be grouped by a category (such as video streaming, or a service such as YouTube—see FIG. 10). Grouping logic may also be modified to consolidate activities into a simpler and easy-to-read format. For example, as illustrated in FIG. 11, an inactivity buffer may be implemented to group services with pauses between use. If two separate flows identified as an identical service—Netflix as an example—are separated by less than 120 seconds from each other, then the conversations may be collectively defined as a single continuous flow (having a single activity—FIG. 11a). If any conversation within the group start at least 120 seconds or more from a previous conversation, then a new flow and new activity is defined (FIG. 11b). The 120 second threshold may be considered as the maximum pause duration for determining when to start a new flow. In other embodiments, the maximum pause duration may be defined with a different duration than 120 seconds.

If the video streaming activity's combined upload/download bytes is below a pre-defined threshold then the activity may be treated as a Web/App activity. In particular embodiments, a threshold of 5,000,000 combined upload and download bytes (or 5 megabytes) is used. However, if the video streaming activity's combined upload/download bytes is at or exceeds the threshold, then the inquiry turns to whether the activity contains more than one conversation. If more than one conversation is detected then the activity duration is defined as the difference between the conversation with the earliest start time and the conversation with the latest end time within the activity (FIG. 11b). Otherwise, if more than one conversation is not detected, then the activity duration is defined as the flow difference time. Activity duration may be defined in hours, minutes (e.g. 4 h 35 m).

Similar methods such as those described above for identifying video streaming activities may be used to identify other types of activities. The types of activities which may be supported by the network monitoring device for identification may include, for example, video streaming, audio streaming, video calling, gaming, social media use, messaging, email, Web and/or other apps, and the like. For each activity type, there may be a specific total upload/download amount threshold that is set to differentiate between that activity type and other activity types (e.g. Web and/or other app activity), irrelevant or insignificant activity, or between incoming data which may be passive activities, and outgoing data which may be active activities. For example, in the case of audio streaming or gaming, the threshold may be set at 1 MB. Any flow having activity below 1 MB may be deleted from the daily report table as being irrelevant or insignificant. In the case of video calling, the threshold may be set at 5 MB. For social media or web/other activity, any flow having activity below 200 kB may be deleted from the daily report table as being irrelevant or insignificant. The threshold for deletion may be lower for other types of activities (such as for email and messaging). For any flow having video calling activity below 5 MB, the video calling activities may be determined by a device name or device hostname and using the “video calling” header to summarize total audio activities.

In the case of social media, messaging, email activities or Web/App activities, a count may be done of the number of separate activities per service. The statistics may be displayed as the total number of activities in the reporting period (for example: Social media, accessed 50 times).

In particular embodiments, certain levels of activities identified by the network monitor device 28 may be applied to place restrictions on the network activity. For example, if a particular network device is identified as engaging in video streaming activity above a threshold duration over the course of a predefined period (e.g. a cumulative 2 hours of video streaming over a 24 hour period), the network monitor device 28 may be configured to limit that network device's access to video streaming activity to ensure that the user does not exceed their allowed duration of video streaming. Once the limit is reached, any packet that comes into the network that is identified as video streaming is blocked by the network monitoring device 28 (i.e. the packets are dropped when it reaches the network monitoring device 28; it does not pass these packets to the intended network device). In particular embodiments, the network monitor device 28 may be configured to limit a network device's access to one or more sites. A graphical user interface tool may be provided which allows an administrative user of the network monitor device 28 to view reports and set desired restrictions on network activity and/or the network device's access to certain sites in view of the reported activities.

In other embodiments, an alert system may be applied to the system through various delivery systems, such as email, Short Message Service (SMS) alerts, or in-application alerts. Alerts may include: new devices that connect to the user's WiFi network, or if monitoring device 28 is knowingly or unknowingly disconnected and unplugged, in which case in particular embodiments the device's battery backup 44 will continue to power the device for a period of time to allow such alerts to be sent provided that the device is still connected to the Internet, for example, by way of Ethernet connection. Alerts may also be applied to specific devices, such as whether certain services are accessed (such as an application or website), or whether usage occurs outside of specified time parameters (such as bedtime).

Other embodiments may apply usage schedules for devices. Schedules may be applied for all devices, or specific devices. A schedule may dictate specific use time for a device to access the internet. In cases where schedules are implemented, alerts may become unnecessary as the user is blocked from using the WiFi network outside of sanctioned usage periods.

Another embodiment may include the blocking of specified Uniform Resource Locators (URL's). These URL's may be specified by the user or by the system, such as for example identified malicious URL's that may infect the user's devices with malware. If a user attempts to access the URL, the system would redirect the user to a webpage explaining the block and the reason for blocking. The user-specified embodiment may also allow the user to enter a single or list of URL's and assign the URL restriction to apply to a single specific device, or to multiple, or all devices on the network. When such a restriction is placed on an applicable device, a similar webpage message will be displayed explaining the restriction.

It will be understood by a person skilled in the art that many of the details provided above are by way of example only, and are not intended to limit the scope of the invention which is to be determined with reference to the following claims.

It can be seen from the above that the present technology may be implemented in a way that makes it very simple for even a non-technical user to add a monitoring device 28 to a local network (e.g. by plugging the monitoring device 28 into a gateway device and to a source of power). After simple configuration steps the monitoring device operates to apply logic (e.g. Systems A and B as described above) to identify the nature of data passing into and/or out of the network and provide the user with easy-to understand reports that identify activities performed using devices on the network. Such a device 28 may, for example be used by parents to verify sensible use of the internet by their children.

### Interpretation of Terms

Unless the context clearly requires otherwise, throughout the description and the claims:
“comprise”, “comprising”, and the like are to be construed in an inclusive sense, as opposed to an exclusive or exhaustive sense; that is to say, in the sense of “including, but not limited to”;
“connected”, “coupled”, or any variant thereof, means any connection or coupling, either direct or indirect, between two or more elements; the coupling or connection between the elements can be physical, logical, or a combination thereof;
“herein”, “above”, “below”, and words of similar import, when used to describe this specification, shall refer to this specification as a whole, and not to any particular portions of this specification;
“or”, in reference to a list of two or more items, covers all of the following interpretations of the word: any of the items in the list, all of the items in the list, and any combination of the items in the list;
the singular forms “a”, “an”, and “the” also include the meaning of any appropriate plural forms.

Embodiments of the invention (e.g. a network monitoring device as described herein) may be implemented using specifically designed hardware, configurable hardware, programmable data processors configured by the provision of software (which may optionally comprise “firmware”) capable of executing on the data processors, special purpose computers or data processors that are specifically programmed, configured, or constructed to perform one or more steps in a method as explained in detail herein and/or combinations of two or more of these. Examples of specifically designed hardware are: logic circuits, application-specific integrated circuits (“ASICs”), large scale integrated circuits (“LSIs”), very large scale integrated circuits (“VLSIs”), and the like. Examples of configurable hardware are: one or more programmable logic devices such as programmable array logic (“PALs”), programmable logic arrays (“PLAs”), and field programmable gate arrays (“FPGAs”)). Examples of programmable data processors are: microprocessors, digital signal processors (“DSPs”), embedded processors, graphics processors, math co-processors, general purpose computers, server computers, cloud computers, mainframe computers, computer workstations, and the like. For example, one or more data processors in a control circuit for a device may implement methods as described herein by executing software instructions in a program memory accessible to the processors.

Processing may be centralized or distributed. Where processing is distributed, information including software and/or data may be kept centrally or distributed. Such information may be exchanged between different functional units by way of a communications network, such as a Local Area Network (LAN), Wide Area Network (WAN), or the Internet, wired or wireless data links, electromagnetic signals, or other data communication channel.

For example, while processes or blocks are presented in a given order, alternative examples may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed in parallel, or may be performed at different times.

In addition, while elements are at times shown as being performed sequentially, they may instead be performed simultaneously or in different sequences. It is therefore intended that the following claims are interpreted to include all such variations as are within their intended scope.

Software and other modules may reside on servers, workstations, personal computers, tablet computers, and other devices suitable for the purposes described herein. Those skilled in the relevant art will appreciate that aspects of the system can be practised with other communications, data processing, or computer system configurations, including: Internet appliances, hand-held devices (including personal digital assistants (PDAs)), wearable computers, all manner of cellular or mobile phones, multi-processor systems, microprocessor-based or programmable consumer electronics (e.g., video projectors, audio-visual receivers, displays, such as televisions, and the like), set-top boxes, network PCs, mini-computers, mainframe computers, and the like.

The invention may also be provided in the form of a program product. The program product may comprise any non-transitory medium which carries a set of computer-readable instructions which, when executed by a data processor, cause the data processor to execute a method of the invention. Program products according to the invention may be in any of a wide variety of forms. The program product may comprise, for example, non-transitory media such as magnetic data storage media including floppy diskettes, hard disk drives, optical data storage media including CD ROMs, DVDs, electronic data storage media including ROMs, flash RAM, EPROMs, hardwired or preprogrammed chips (e.g., EEPROM semiconductor chips), nanotechnology memory, or the like. The computer-readable signals on the program product may optionally be compressed or encrypted.

In some embodiments, the invention may be implemented in software. For greater clarity, “software” includes any instructions executed on a processor, and may include (but is not limited to) firmware, resident software, microcode, and the like. Both processing hardware and software may be centralized or distributed (or a combination thereof), in whole or in part, as known to those skilled in the art. For example, software and other modules may be accessible via local memory, via a network, via a browser or other application in a distributed computing context, or via other means suitable for the purposes described above.

Where a component (e.g. a software module, processor, assembly, device, circuit, etc.) is referred to above, unless otherwise indicated, reference to that component (including a reference to a “means”) should be interpreted as including as equivalents of that component any component which performs the function of the described component (i.e., that is functionally equivalent), including components which are not structurally equivalent to the disclosed structure which performs the function in the illustrated exemplary embodiments of the invention.

Specific examples of systems, methods and apparatus have been described herein for purposes of illustration. These are only examples. The technology provided herein can be applied to systems other than the example systems described above. Many alterations, modifications, additions, omissions, and permutations are possible within the practice of this invention. This invention includes variations on described embodiments that would be apparent to the skilled addressee, including variations obtained by: replacing features, elements and/or acts with equivalent features, elements and/or acts; mixing and matching of features, elements and/or acts from different embodiments; combining features, elements and/or acts from embodiments as described herein with features, elements and/or acts of other technology; and/or omitting combining features, elements and/or acts from described embodiments.

It is therefore intended that the following appended claims and claims hereafter introduced are interpreted to include all such modifications, permutations, additions, omissions, and sub-combinations as may reasonably be inferred. The scope of the claims should not be limited by the preferred embodiments set forth in the examples, but should be given the broadest interpretation consistent with the description as a whole.

What is claimed is:

1. A method of monitoring network activity, comprising:
monitoring incoming and outgoing packets communicated on a network to capture packet data;
assembling the captured packet data into one or more flows;
storing the one or more flows in a database; and
processing the one or more flows to identify an activity for each one of the one or more flows.

2. The method according to claim 1, comprising:
identifying a potential security threat by detecting a pattern of unusual internet traffic based on the monitored outgoing packets.

3. The method according to claim 1, comprising identifying a source IP address and a destination IP address of each packet captured on the network and wherein assembling the packet data into the one or more flows comprises organizing the packet data by conversations between unique groups of IP addresses on the network.

4. The method according to claim 3, wherein for each one of the one or more flows, one or more attributes are defined from the packet data, wherein the one or more attributes comprises one or more of: source IP address; destination IP address; Domain Name System (DNS) request or query; DNS response IP address and name; Uniform Resource Locator (URL); sent packets; sent bytes; received packets; received bytes; ports accessed; start time; end time; MAC address; device hostname; and one or more deep packet inspection-derived (DPI) protocol fields.

5. The method according to claim 4 wherein processing the one or more flows comprises identifying whether the activity for each one of the one or more flows is one of video streaming, audio streaming, video calling, social media use, gaming, messaging, email messaging, web browsing, and/or desktop/mobile application use, based at least in part on the one or more attributes.

6. The method according to claim 5 wherein processing the one or more flows comprises using at least one of the following to identify the activity: packet translation logic; a keyword dictionary; port number tables; bandwidth thresholds; application layer protocols; Internet Protocol (IP) tables, and predictive logic.

7. The method according to claim 6, comprising, for each of the one or more flows, determining activity information comprising one or more of: a start time and an end time for the activity; a duration of the activity; and a number of times that the activity was performed or accessed in a reporting period.

8. The method according to claim 7 comprising producing a plurality of network activity reports at predetermined regular intervals displaying, for each one of the one or more flows, the activity and the activity information.

9. The method according to claim 2 comprising notifying a system administrator of potential security threats as they are detected.

10. The method according to claim 6 wherein the one or more attributes comprises a DPI protocol field, and the method comprises, for each one of the one or more flows:
parsing the DPI protocol field;
searching for a corresponding record in the keyword dictionary that matches the parsed DPI protocol field; and
if a corresponding record is located, assigning data from the corresponding record to the flow.

11. The method according to claim 10, comprising, for each one of the one or more flows, assigning a placeholder activity type to the flow if no corresponding record is located.

12. The method according to claim 10, comprising deleting the flow if the data assigned to the flow identifies the flow as being associated with an exclusion.

13. The method according to claim 10, comprising deleting the flow if a total upload or download amount for the flow is below a certain threshold for the activity of the flow.

14. The method according to claim 13 wherein the threshold is in the range of 25 kB to 1 MB.

15. The method according to claim 10 comprising grouping conversations having the same activity type and accessing network device into a group, wherein successive conversations within the group are identified as comprising a continuous flow until a maximum pause duration between conversations is exceeded, in which case any conversation starting after the maximum pause duration has lapsed is detected as a separate flow from the previous flow.

16. The method according to claim 15 wherein the maximum pause duration is 120 seconds.

17. The method according to claim 15 wherein if more than one conversation is detected within the group, the activity duration is defined as a difference between the conversation with the earliest start time and the conversation with the latest end time, and if more than one conversation is not detected, the activity duration is defined as the flow difference time.

18. The method according to claim 11 comprising determining a rate of transmission of the flow over a certain period and identifying the activity based on the rate of transmission over the period.

19. The method according to claim 11 comprising counting a number of SMTP requests in the flow made over a certain period and identifying and/or flagging the flow if the number of SMTP requests exceeds a threshold.

20. A method of monitoring network activity, comprising:
monitoring incoming and outgoing packets communicated on a network to capture packet data;
assembling the packet data into one or more flows between unique pairs of IP addresses on the network;
for each one of the one or more flows:
determining a first set of attributes based on the packet data in the flow;
processing the flow to determine an activity, wherein processing the flow comprises determining a second set of attributes by using one or more attributes of the first set of attributes to derive the second set of attributes from a repository, and applying the second set of attributes to identify a first activity type.

21. The method according to claim 20, wherein the first set of attributes comprises one or more of:
source IP address; destination IP address; Domain Name System (DNS) request or query; DNS response IP address and name; Uniform Resource Locator (URL); sent packets; sent bytes; received packets; received bytes; ports accessed; start time; end time; MAC address; device hostname; and one or more deep packet inspection-derived (DPI) protocol fields.

22. The method according to claim 21, wherein the second set of attributes comprises one or more of:
a category, a service, and a subcategory.

23. The method according to claim 22 comprising, for each one of the one or more flows, determining based on one or more of the first set of attributes and the second set of attributes whether the flow is directed to a website that is a security risk, and monitoring the flow.

24. The method according to claim 20 wherein processing the flow comprises applying predictive logic to one or more of the first set of attributes and the second set of attributes to identify a second activity type, wherein applying predictive logic comprises identifying patterns in one or more of: upload and/or download speed, rate of transmission, duration of continued transmission, and number of requests sent by the requesting device.

25. The method of claim 24 comprising selecting the first activity type as being associated with the flow where the first activity type differs from the second activity type, and selecting the second activity type as being associated with the flow where the first activity type is unable to be determined through the first and/or second sets of attributes.

26. The method according to claim 24, comprising periodically reporting the activity electronically to a user on a user-specified schedule through one or more of email communication, a mobile application, SMS messaging and a web interface.

27. The method as claimed in claim 24, comprising generating a real-time warning regarding the activity if the information generated by processing the flow meets user-specified parameters.

28. An apparatus for monitoring network activity, comprising:
a packet sniffer configured to monitor incoming and outgoing packets communicated on a network to capture packet data; and
a packet analyzer configured to:
assemble the captured packet data into one or more flows;
cause the one or more flows to be stored in a database; and
process the one or more flows to identify an activity for each one of the one or more flows.

29. The apparatus according to claim 28, wherein the packet analyzer is configured to identify a source IP address and a destination IP address of each packet captured on the network and to assemble the packet data into the one or more flows by organizing the packet data by conversations between unique groups of IP addresses on the network.

30. The apparatus according to claim 29, wherein for each one of the one or more flows, the packet analyzer is configured to define one or more attributes from the packet data, wherein the one or more attributes comprises one or more of: source IP address; destination IP address; Domain Name System (DNS) request or query; DNS response IP address and name; Uniform Resource Locator (URL); sent packets; sent bytes; received packets; received bytes; ports accessed; start time; end time; MAC address; device hostname; and one or more deep packet inspection-derived (DPI) protocol fields.

31. The apparatus according to claim 30 wherein the packet analyzer is configured to process the one or more flows to identify whether the activity for each one of the one or more flows is one of video streaming, audio streaming, video calling, social media use, gaming, messaging, email messaging, web browsing, and/or desktop/mobile application use, based at least in part on the one or more attributes.

32. The apparatus according to claim 31 wherein the packet analyzer is configured to process the one or more flows by using at least one of the following to identify the activity: packet translation logic; a keyword dictionary; port number tables; bandwidth thresholds; application layer protocols; Internet Protocol (IP) tables, and predictive logic.
